(19) United States
(12) Patent Application Publication
(10) Pub. No.: US 2008/0181298 A1
(43) Pub. Date: Jul. 31, 2008

(54) HYBRID SCALABLE CODING

(75) Inventors: Xiaojin Shi, Santa Cruz, CA (US); Hsi-Jung Wu, San Jose, CA (US); James Oliver Normile, Los Altos, CA (US)

Correspondence Address: KENYON & KENYON LLP, 1500 K STREET NW, SUITE 700, WASHINGTON, DC, 20005-1257, US

(73) Assignee: APPLE COMPUTER, INC., Cupertino, CA (US)

(21) Appl. No.: 11/627,457

(22) Filed: Jan. 26, 2007

(51) Int. Cl. H04N 7/32; H04N 7/26

(52) U.S. Cl. 375/240.03; 375/240.26; 375/240.12; 375/240.16; 375/E07.125

(57) ABSTRACT

Systems, apparatuses and methods whereby coded bitstreams are delivered to downstream end-user devices having various performance capabilities. A head-end encoder/video store generates a primary coded bitstream and metadata for delivery to an intermediate re-encoding system. The re-encoding system recodes the primary coded bitstream to generate secondary coded bitstreams based on coding parameters in the metadata. Each secondary coded bitstream is matched to a conformance point of a downstream end-user device. Coding parameters for each conformance point can be derived from the head-end encoder encoding original source video to generate the secondary coded bitstreams and extracting information from the coding process/results. The metadata can then can be communicated as part of the primary coded bitstream (e.g., as SEI) or can be communicated separately. As a result, the complexity of the secondary coded bitstream is appropriately scaled to match the capabilities of the downstream end-user device to which it is delivered.

### BACKGROUND OF THE INVENTION

1. Field of the Invention

The present invention generally relates to distribution of encoded video. More specifically, the present invention uses a hybrid scalable coding scheme to deliver customized encoded bitstreams to downstream devices having various performance capabilities.

2. Background Art

FIG. 1 illustrates a hypothetical video distribution system 100. Video distribution systems often include a video encoder 102 and a number of end-user decoder devices 106-1 through 106-N. The video encoder 102 and the end-user devices 106 are connected via a communications network 104.

The video encoder 102 receives source video data from a video source (e.g., a storage medium or a video capture device). The video encoder 102 codes the source video into a compressed bitstream for transmission or delivery to an end-user device 106. The end-user device 106 decodes the compressed bitstream to reconstruct the source video data. The end-user device 106 can then provide the reconstructed source video data to a video display device.

The encoder 102 typically operates to generate a video bitstream for each end-user device 106 based on the performance capabilities of each end-user device 106. In many applications, the end-user devices 106-1 through 106-N comprise identical or virtually identical devices and may be produced by the same manufacturer. As such, the performance capabilities and characteristics of each of the end-user devices 106-1 through 106-N are substantially similar. Consequently, the encoder 102 can often encode the source video data a single time based on the universal quality requirements of the downstream end-user devices 106. The encoder 102 can then deliver the same copy of the resulting compressed bitstream to each of the end user devices 106 as needed.

In more advanced video distribution systems, the variety of end-user devices 106 is expansive. In particular, the end-user devices 106 may have different computational capabilities and may be produced by different manufacturers. As a result, the end-user devices 106 collectively exhibit a wide range of varying performance capabilities, operating profiles and quality preferences. Each combination of these performance characteristics can be considered as representing a different conformance operating point or operation profile. An end-user device 106 operating at a lower conformance operating point typically has fewer decoding capabilities than an end-user device 106 operating at a higher conformance operating point, which is typically used to render source video onto a larger display with better quality and resolution. For example, a PC having a relatively large display may have more decoding resources at its disposal (e.g., more processing power/speed, more memory space, more dedicated decoding hardware, and/or fewer power limitations) than a portable video playback device having a relatively small display and perhaps limited battery life (e.g., a video IPOD). The quality of the reproduced source video typically improves with a more complex coded bitstream (e.g., higher bit rate with more encoded information). Consequently, the compressed bitstream delivered to the end-user device 106 operating at the lower conformance operating point is typically of a lower complexity (and therefore lower quality) than the compressed bitstream delivered to the end-user device 106 operating at the higher conformance operating point.

If the complexity of the compressed bitstream provided to an end-user device 106 is lower than an expected complexity based on the conformance operating point of the end-user device 106, then the quality of reproduced video may suffer unnecessarily. Under this scenario, the full decoding and rendering capabilities of the end-user device 106 may not be efficiently exploited. Similarly, if the complexity of the compressed bitstream provided to an end-user device 106 is higher than an expected complexity based on the conformance operating point of the end-user device 106, then the decoding burden placed on the end-user device 106 may be overwhelming. Under this scenario, the end-user device 106 may not be able to properly reproduce the original source video or may face unexpected time and power penalties during decoding of the supplied compressed bitstream.

The end-user devices 106 themselves also may support operation across multiple conformance points. The conformance point of an end-user device 106 may vary over time based on such factors as the availability of power resources or preferences of the end-user device 106 as determined by a user of end-user device 106. For example, as battery resources are reduced, an end-user device 106 may drop down to a lower quality conformance point to decrease decoding and/or rendering burdens to conserve resources. Additionally, a user may instruct an end-user device 106 to increase or decrease video reconstruction complexity (e.g., by specifying a change in resolution, screen size, video quality, etc.), thereby causing a change in the conformance operating point of the end-user device 106. Overall, under a complex video distribution environment, the encoder 102 may need to generate multiple compressed bitstreams to accommodate the wide range of conformance points dynamically imposed on the encoder 102 by the downstream end-user devices 106. The complexity of each compressed bitstream may be scaled to correspond to a particular conformance point.

One solution for providing each end-user device 106 with an appropriate complexity-scaled bitstream involves the encoder 102 generating coded bitstreams for each conformance point or supported class of operation. This approach may face significant bandwidth constraints as the number of conformance points increases and/or if several different bitstreams are used by a client process which services multiple end-user devices 106. The quality of the video reproduced from the provided coded bitstreams may be sacrificed to enable a limited bandwidth connection to support delivery of the multiple coded bitstreams. Further, scalability may suffer as the capabilities and number of the end-user devices 106 expand, thereby increasing the number of downstream conformance operation points beyond what is properly serviceable. Also, this approach will impose significant storage and maintenance burdens on the server side (e.g., the encoder 102).

An alternative solution for providing coded bitstreams to accommodate each end-user device 106 is the scalable video coding (SVC) technique currently being developed by the International Standards Organization (ISO). In this approach, a single bitstream is provided by a head-end encoder. The SVC bitstream is composed of a very low quality base layer bitstream along with multiple higher quality enhancement layers. With this approach, decoding only the base layer reconstructs video of a low quality and so only satisfies those playback devices having conformance points corresponding to the base layer. To reconstruct video having improved quality, the playback device decodes the base layer and one or more enhancement layers. The additional computational burden of decoding the proper combination of enhancement layers for a specific conformance point is placed on the playback device, which may have very limited computation resources (e.g. a handheld playback device). Accordingly, to satisfy a range of conformance points, the SVC approach places a large computational burden on downstream playback devices that may have limited power and decoding resources. Further, the proposed SVC standard requires most currently deployed decoders to be retrofitted with SVC codecs to provide interoperability. Consequently, adherence to the proposed standard faces high rollout and administrative costs.

Another solution for providing coded bitstreams to accommodate each end-user device 106 is to use an intermediary transcoding device. Under this scenario, the transcoding device recodes one or more received coded bitstreams into a coded bitstream customized to a particular conformance point. More computational burden is placed on the transcoder when a less sophisticated transcoding scheme is employed. Less sophisticated transcoding schemes generally require the transcoder to perform a full decoding and subsequent full re-encoding of the original coded bitstream to produce a customized coded bitstream. This computational burden can be significant and can typically only be reduced by a tradeoff in visual quality. Less computational burden can be imposed on the transcoder by using a more sophisticated transcoding scheme. More complex transcoding schemes can reduce encoding complexity but generally at the expense of limiting scalability. That is, the complexity of the transcoding scheme can increase as the number and range of conformance points expands. Picture quality may ultimately suffer in order to service the expansive range of conformance points if minimal encoding complexity is to be maintained. Further, a more complex transcoding scheme generally reduces the speed of the transcoding process. This time penalty can be an unacceptable cost in many applications that require real-time encodings. Thus, current transcoding techniques are largely inadequate.

Accordingly, what is needed is a low complexity transcoding scheme that can produce coded bitstreams for a wide range of downstream conformance points that can be implemented by currently deployed encoder-decoder systems at low cost.

### BRIEF DESCRIPTION OF THE DRAWINGS

The accompanying drawings illustrate the present invention and, together with the description, further serve to explain the principles of the invention and to enable one skilled in the pertinent art to make and use the invention.

FIG. 1 illustrates a hypothetical video distribution system.

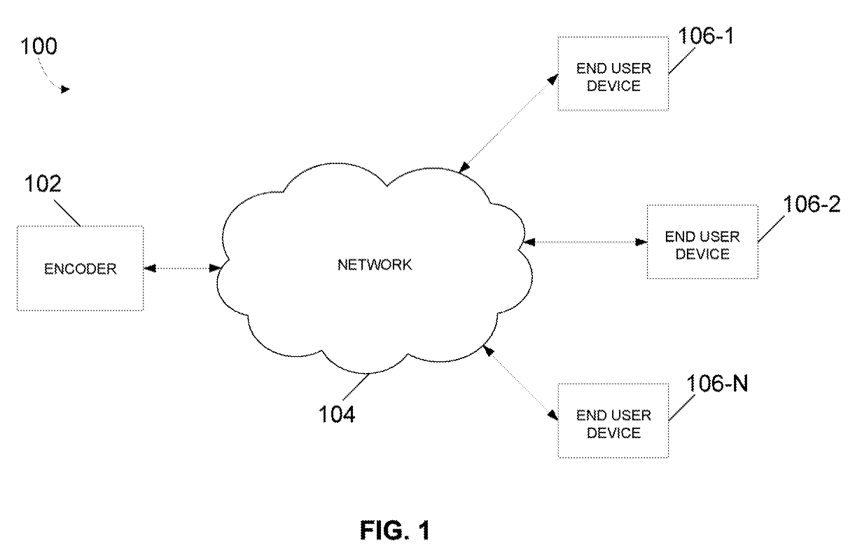

FIG. 2 illustrates a video distribution system according to an embodiment of the present invention.

FIG. 3 is a functional block diagram of a decoder according to an embodiment of the present invention.

FIG. 4 is a functional block diagram of an intermediate encoder according to an embodiment of the present invention.

FIG. 5 illustrates a transmission signal generated by an encoder of the present invention for delivery to an intermediate re-encoder of the present invention.

FIG. 6 is a simplified functional block diagram of a computer system.

### DETAILED DESCRIPTION OF THE INVENTION

Embodiments of the present invention provide systems, apparatuses and methods by which coded video data bitstreams are delivered efficiently to downstream end-user devices having various performance capabilities and operational characteristics. A head-end encoder/video store may generate a single primary coded bitstream that is delivered to an intermediate re-encoding system. The head-end encoder/video store may also provide re-encoding hint information or metadata to the intermediate re-encoding system. The intermediate re-encoding system re-encodes the primary coded bitstream to generate multiple secondary coded bitstreams based on the provided metadata. Each secondary coded bitstream may be matched to a conformance operating point of an anticipated downstream end-user device or a class of downstream end-user devices. The metadata provided by the head-end encoder/video store may be derived from encoding operations conducted by the head-end encoder/video store. That is, the head-end encoder may perform encoding operations to generate the secondary coded bitstreams and then extract coding parameters from the coding process/results to provide as the metadata. Coding parameters can also be derived or inferred based on the encoding of the primary coded bitstream or the encoding of one or more secondary coded bitstreams. The coding parameters can subsequently be communicated with the primary coded bitstream to the intermediate re-encoding system. The coding parameters can be encoded as part of the primary coded bitstream and communicated contemporaneously with the coded video data. The coding parameters can alternatively be encoded as a separate bitstream and either communicated on a separate, dedicated channel or downloaded as an entirely distinct and separate file at a later time. As a result, coded bitstreams can be matched to the diverse decoding and video rendering capabilities of the downstream end-user devices. Further, the computational burden imposed on the intermediate re-encoding system is significantly reduced by exploiting the provided re-encoding information. The bulk of the encoding computational burden can therefore be placed on the head-end encoder/video store, rather than a transcoding device, which is better suited to handle the multiple encoding operations and extraction/determination of coding parameter information. Further, the computational burden imposed on the end-user devices is reduced.

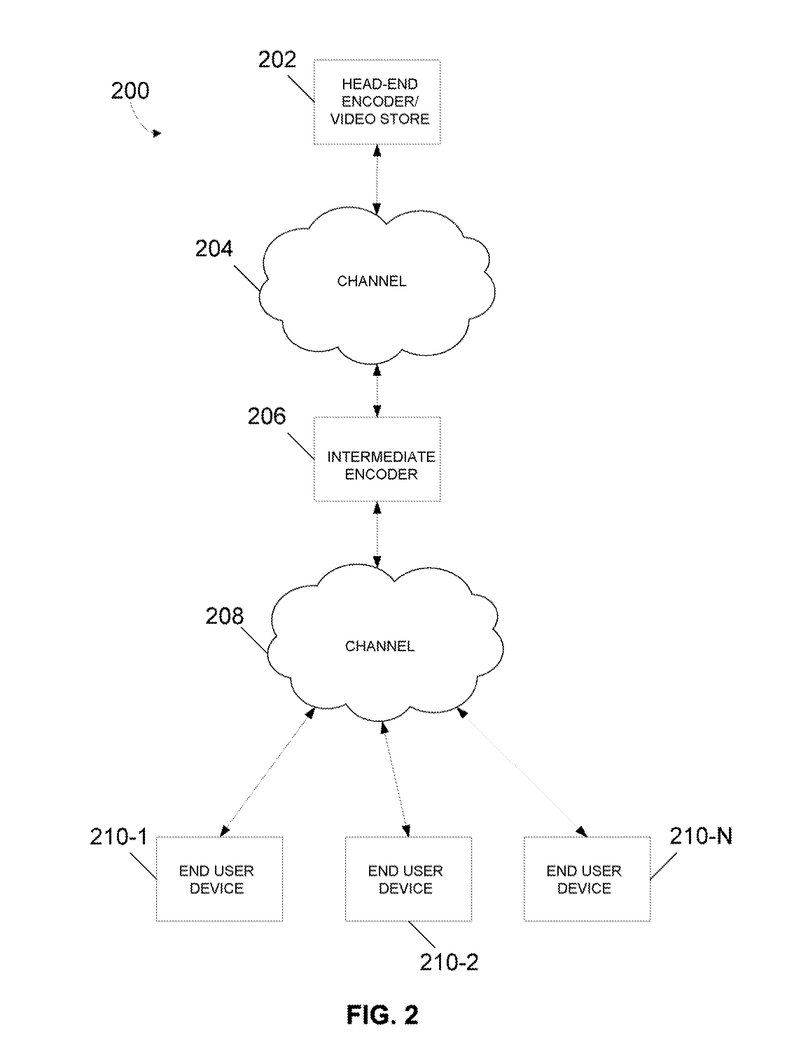

FIG. 2 illustrates a video distribution system 200 according to an embodiment of the present invention. The video distribution system 200 includes a head-end encoder 202, an intermediate encoder 206 and a number of end-user devices 210-1 through 210-N. The head-end encoder 202 can be connected to the intermediate encoder 206 via a first communication channel 204. The intermediate encoder 206 can be connected to end-user devices 210-1 through 210-N over a second communication channel 208. The first and second communication channels 204 and 208 can be any type of communication channels or networks such as, but not limited to, a computer or data network (e.g., such as the Internet, WiFi or firewire or some other WLAN or LAN conforming to a known computer networking protocol). Further, the first and second communication channels 204 and 208 can exploit any type of physical medium for signaling including, but not limited to, wireless, wireline, cable, infrared, and optical mediums. Overall, the topology, architecture, medium and protocol governing operation of the first and second communication channels 204 and 208 are immaterial to the present discussion unless specifically identified herein.

The head-end encoder 202 functions as a source of encoded video data. The head-end encoder 202 can encode source video data from a video source and/or can include a repository of stored encoded video or source video data. The intermediate encoder 206 operates as a bridging device between the encoded video data available from the head-end encoder 202 and the end-user devices 210. The intermediate encoder 206 can operate as a satellite server which provides encoded video data, originally generated and/or stored at the head-end 202, to one or more end user devices 210. For example, the intermediate encoder 206 can be a client system, such as an iTunes server, which services the end-user devices 210. The intermediate encoder 206 can also be a client or server or local PC. The end-user devices 210 can be any variety of video decoding and/or video display devices that individually can support multiple conformance points and collectively represent a wide range of conformance points or classes of operation.

The head-end encoder 202 is shown connected to a single intermediate encoder 206 but is not so limited. That is, the head-end encoder 202 can be connected to a number of intermediate encoders 206. Likewise, the intermediate encoder 206 is shown connected to a single head-end encoder 202 but is not so limited as the intermediate encoder 206 can be connected to a number of head-end encoders 202.

The video distribution system 200 and its constituent components can implement and operate in accordance with a variety of video coding protocols such as, for example, any one of the Moving Picture Experts Group (MPEG) standards (e.g., MPEG-1, MPEG-2, or MPEG-4) and/or the International Telecommunication Union (ITU) H.264 standard.

The head-end encoder 202 provides a single primary coded bitstream to the intermediate encoder 206. The head-end encoder also provides accompanying metadata to the intermediate encoder 206. The intermediate encoder 206 uses the primary coded bitstream as the source for generating multiple secondary coded bitstreams to service the various downstream conformance points. Specifically, the source primary coded bitstream and the supplemental metadata can be used to generate one or more coded bitstreams tailored to each conformance point associated with the downstream end-user devices 210. Therefore, a coded bitstream designed to service a particular conformance point associated with one or more downstream end-user devices 210 can be formed by (a) extracting/determining from the metadata the coding parameters associated with a particular conformance point and (b) re-encoding the primary coded bitstream based on the coding parameters corresponding to the target conformance point.

The use of the supplemental coding parameters enables the intermediate encoder 206 to appropriately scale the complexity of a re-encoded output signal to ensure each end-user device 210 receives a coded bitstream commensurate with its decoding and video rendering capabilities. Further, the use of the supplemental coding parameters reduces the computational burden placed on the intermediate encoder 206 and enables fast encoding/re-encoding. In this way, the coded bitstreams delivered to each end-user device 210 can be matched to its conformance point. This allows the end-user device 210 to receive a coded signal of an expected quality and complexity allowing the full capabilities of the end-user device 210 to be better exploited. In turn, the quality of the video reproduced by the end-user device 210 on an associated display can meet expectations. Additionally, each end-user device 210 can decode a received re-encoded bitstream using currently available software and/or hardware without the need to be retrofitted with updated decoding mechanisms.

The primary coded bitstream can be matched to a type of downstream end-user device 210. For example, the primary coded data can be matched to a type of downstream end-user device 210 corresponding to a maximum conformance operating point. The primary coding bitstream can be encoded by the head-end encoder according to a coding profile matching the maximum conformance operating point (e.g., a primary coding profile). The maximum conformance operating point can represent a highest level of decoding and rendering capabilities. A downstream end-user device 210 operating at the maximum conformance operating point may therefore be capable of processing a coded bitstream having a highest scaled complexity relative to the complexity of the other secondary coded bitstreams. Under this scenario, the intermediate encoder 206 can recode the primary coded bitstream to generate secondary coded bitstreams of a lower complexity/quality. Alternatively, the primary coded data can be matched to a type of downstream end-user device 210 corresponding to some other conformance operating point.

The metadata accompanying the primary coded bitstream can provide information directed to a number of conformance points. The head-end encoder 202 can encode original source data as many times as necessary to generate the coding parameters necessary to support each downstream conformance point. For example, the head-end encoder 202 can encode the source data according to a plurality of secondary coding profiles. The plurality of secondary coding profiles can be matched to conformance operating point information of anticipated downstream devices such that a plurality of corresponding secondary coded bitstreams are generated by the repeated encoding process. At the end of each encoding processes, encoding/decoding/re-encoding information can be extracted and can form the coding parameters to be supplied to the intermediate encoder 206. The head-end encoder 202 can also determine the coding parameters for a particular conformance point by deriving them based on the coding parameters associated with one or more different conformance points. For example, the coding parameters for a conformance point/secondary coded bitstream may be inferred from the coding parameters determined for a closely related conformance point. The head-end encoder 202 can then subsequently generate the primary coded bitstream for download to the intermediate encoder 206. In this way, the head-end decoder 202 can determine the coding information to enable the intermediate encoder 206 to generate each coded bitstream with significantly reduced computational burden.

The head-end encoder 202 can handle the largest computational burden involved in distributing the proper coded bitstreams to each end-user device 210. This improves the likelihood that the coded bitstreams will match the downstream conformance points as the head-end encoder 202 is best equipped, in terms of available hardware, software and power resources, to handle the coding parameter determination process and does not face the real-time delivery requirements imposed on the intermediate encoder 206 by the end-user devices 210.

The metadata determined by the head-end encoder 202 can be communicated over a dedicated channel that is separate from the primary coded video signal provided to the intermediate encoder 206 (e.g., by using out-of-band signaling). For example, the metadata can be interleaved with the received primary coded video signal according to a known pattern or formatting scheme adopted by the video distribution system 200. Overall, the out-of-band signaling mechanism employed between the head-end encoder 202 and the intermediate encoder 206 is immaterial to the present discussion unless specifically identified herein.

The metadata can also be encoded as part of the primary coded bitstream and delivered contemporaneously with the primary coded bitstream. For example, the metadata can be encoded as Supplemental Enhancement Information (SEI) in accordance with the Advanced Video Coding (AVC)/H.264 standard. To exploit the metadata provided in SEI messages, a protocol for representing metadata information within SEI messages can be established between the head-end encoder 202 and the intermediate encoder 206. Such a protocol can be pre-known between the two devices or can be later learned or provided. Exploitation of the metadata can therefore be restricted to those downstream devices that are privy to the communication protocol governing information representation within the SEI messages. In this way, restricted access or use of the metadata can be enforced. On the other hand, the SEI messages constitute part of an AVC conformed bitstream. Therefore, the potential for existing downstream devices (including 3^{rd} party devices) to easily exploit the metadata is increased without the need for downstream devices to be retrofitted with additional decoding capabilities. Further, if a device cannot exploit the coding information (e.g., if a device does not know the protocol for communicating information within the SEI messages), then the device can simply ignore the messages and can decode the coded video data without the benefit of re-encoding hint information. SEI messages can also be provided for each frame of coded video data such that decoding/re-coding operations can begin as soon as a portion of the primary coded bitstream is downloaded/received. In this way, it is not necessary to receive the entire primary coded bitstream and metadata before beginning recoding operations.

The metadata can alternatively be encoded as a bitstream separate from the primary coded bitstream. This separate encoded metadata bitstream can be communicated contemporaneously with the primary coded bitstream (e.g., in accordance with an out-of-band signaling technique mentioned above) or can be stored and downloaded separately from the primary coded bitstream.

The end-user devices 210 can receive one or more coded bitstreams from the intermediate encoder 206. That is, a re-encoded bitstream for each possible conformance point of the end-user device 210 can be supplied from the intermediate decoder 206. To generate the secondary coded bitstreams, the intermediate encoder 206 can perform a partial decode/partial re-encode of the primary coded bitstream based on the provided metadata. Alternatively, the intermediate encoder 206 can perform a full decode/full re-encode of the primary coded bitstream based on the provided supplemental metadata. A full decode/full-re-encode of the primary coded bitstream does not substantially increase the computational burden imposed on the intermediate encoder 206 since the supplemental metadata supplies coding parameters to greatly reduce the complexity of the encoding process.

The intermediate encoder 206 can create a customized bitstream that is directly represented by the information conveyed by the metadata. That is, the metadata itself can include a complete coded bitstream of a particular complexity for delivery to an end-user device 210 operating according to a specific conformance point. The intermediate encoder 206 can also generate a coded bitstream that is not directly associated with any of the provided metadata. Under this scenario, the intermediate encoder 206 can adapt the supplied coding parameters to form new or modified coding parameters for use in the re-encoding process. Under this scenario, the intermediate encoder 206 can recode the primary coded bitstream based on the metadata and information received from an end-user device 210 such that a customized bitstream can be generated that is different from a coded bitstream conforming to a previously defined or known conformance point.

The intermediate encoder 206 can also generate a coded bitstream that is not directly associated with any of the provided metadata by deriving new metadata from portions of the supplied metadata. In doing so, a coding profile for a downstream device not directly accounted for in the received metadata can be accommodated by derivation operations conducted by the intermediate encoder 206. New metadata can be derived, for example, by interpolation of coding parameters (e.g., quantization parameters) provided in the received metadata for other coding profiles (e.g., coding profiles closely associated with the “new” coding profile). Interpolation of coding parameters is typically a low cost calculation in terms of required time and power as it does not involve re-encoding the primary coded bitstream or received metadata.

The ability of the intermediate encoder 206 to develop new metadata for a new coding profile based on existing metadata can save resources at the head-end encoder 202. That is, the operations of the head-end encoder 202 can be focused on generating metadata for a limited set of major coding profiles. The intermediate encoder 206 can then use the metadata provided for the major coding profiles to derive metadata for a larger number of sub-coding profiles. This reduces the amount of metadata that is to be produced by the head-end encoder 202. Further, as previously mentioned, the derivation of the extrapolated metadata places a fairly low computational burden on the intermediate encoder 206. As a result, distribution of customized bitstreams to downstream devices can be made to be more efficient by reducing burdens paced on both the head-end encoder 202 and the intermediate encoder 206.

The flexibility of the video distribution system 200 is expanded by the derivation of metadata by the intermediate encoder 206. In particular, the intermediate encoder 206 can derive metadata for a new or 3^{rd} party downstream decoding device that has been recently introduced or made available to the intermediate encoder 206. Additionally, the intermediate encoder 206 can also generate metadata to service a downstream device that is no longer supported by the upstream head-end encoder 202. Therefore, the life of downstream devices can be extended. Overall, the range of coding profiles/conformance operating points that can be supported by the video distribution system 200 is expanded by the derivation of metadata by the intermediate encoder 206 using supplied or received metadata.

As previously mentioned, various coding parameters can be provided in the metadata to the intermediate encoder 206 by the head-end encoder 202. The intermediate encoder 206 can select which provided coding parameters to use to generate a particular customized coded bitstream. Selection can be based on information provided in the metadata. For example, the metadata may indicate which set of coding parameters can be used to generate a particular type of secondary coded signal matched to a particular type of downstream end-user device 210. Selection of coding parameters to use can also be based on information gathered locally by the intermediate encoder 206. Specifically, the end-user devices 210 can register with the intermediate encoder 206, or the video distribution system 200 itself, so that the various downstream conformance points are known and tracked by the intermediate encoder 206.

The intermediate encoder 206 can also receive conformance point information, and changes thereto, from user-supplied information. A user can indicate/set a preference or request a change in reconstructed video size or quality (e.g., resolution). This information can then be used by the intermediate encoder 206 to adjust the re-encoding process by, for example, selecting different coding parameters. User information can also include a timestamp where a change in quality is requested in a particular stream of video. The timestamp can specify where a change in the re-encoding process can occur. This can enable a user to view a portion of a reconstructed video stream having a first quality (e.g., on a PC with a high quality) and then viewing a second portion of the reconstructed video having a second quality (e.g., on a video IPOD having a lower quality). In general, any information provider by the user of an end-user device 210 can be used to adjust or initiate the re-encoding process of the intermediate encoder 206.

Information on the landscape of downstream conformance points can also be shared between the intermediate encoder 206 and the head-end encoder 202. This allows the video distribution system 200 to dynamically accommodate a variable range of conformance points as the head-end encoder 202 can appropriately adjust generation of the metadata and the primary coded bitstream if necessary.

The video distribution system 200 and the operations of the intermediate encoder 206 are compatible with the SVC architecture. In particular, the intermediate encoder 206 can re-encode the primary coded bitstream using one or more enhancement layers received from one more sources of coded video. By re-encoding the primary coded bitstream using one or more enhancement layers, the intermediate encoder 206 can generate a bitstream for a downstream device that has a higher quality than the primary coded bitstream (i.e., is matched to a conformance operating point that is higher than that associated with the primary coded bitstream). In this way, the quality of the bitstreams generated by the intermediate encoder 206 are not limited to the quality of primary coded bitstream it receives from the head-end encoder 202.

A wide range of coding parameters can be supplied by the head-end encoder 202 to the intermediate encoder 206 in the metadata such as, for example:
(a) A fully encoded bitstream—The intermediate decoder 206 can extract the fully encoded bitstream from the metadata and provide it, with or without modification, to an end-user device 210. The encoded bitstream can be one of the secondary coded bitstreams.
(b) Prediction mode decision and/or motion vector information.
(c) Quantization parameters (Qp)—Qp information for each frame or a select portion of frames or each macroblock can be provided and used to adjust the Qps used during re-encoding of the primary coded bitstream.
(d) Resolution scaling/cropping information—This information can be used to increase or decrease the resolution quality of reproduced video in accordance with the preferences/capabilities of the end-user device 210 and/or associated display device. This information can also specify how the coded video should be decoded and rendered for display to accommodate a change in display size, thereby appropriately cropping the reconstructed video.
(e) Low Complexity (LC) profile values for defining the performance capabilities and quality expectations associated with a particular conformance point
(f) Pre-processing instructions to aid intermediate encoder 206 encoding operations to reduce computational burden.
(g) Post-processing instructions to aid intermediate encoder 206 encoding operations to reduce computational burden.
(h) Conformance point/target device identification information—This information can be used to determine the coded bitstream matched to a specific end-user device 210 that may be distinguished by a unique ID or class ID.
(i) No information—The intermediate encoder 206 can either deliver the source primary coded bitstream to an end-user device 210 unmodified and/or can re-encode the primary coded bitstream to produce a new bitstream for downloading. The re-encoding of the original coded bitstream could be based on information the intermediate encoder 206 receives from an end-user device 210.
(j) Temporal scalability information—Temporal scaling often involves the adjustment of a decoded frame rate by adding, dropping or replacing frames. Accordingly, this information can be used by the intermediate encoder 206 to adjust the frame rate of a secondary coded bitstream based on the primary coded bitstream and the provided metadata.
(k) Frame/slice type information—This information can specify a type of frame (e.g., reference or non-reference) and/or slice type.
   Any combination of the above-listed coding parameters can be supplied for any conformance point. Further, these coding parameters can be passed on to the downstream end-user devices 210 to aid their decoding operations.

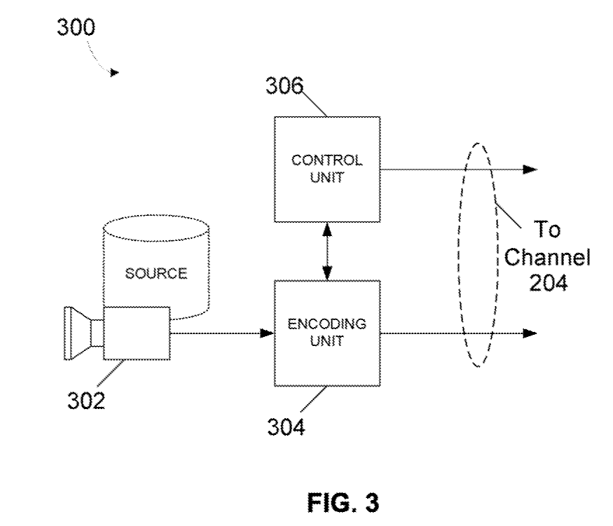

FIG. 3 is a functional block diagram of a head-end encoder 300 according to an embodiment of the present invention. The encoder 300 includes an encoding unit 304 and a control unit 306. The encoding unit 304 can be coupled to a video source 302. The video source 302 provides video data to the encoding unit 304. The video source 302 can include real-time video data generation devices and/or a storage device storing video data. The encoding unit 304 generates the primary coded bitstream for delivery to an intermediate encoding device. The encoder 300 generates and provides metadata to accompany the primary coded bitstream to the intermediate encoding device. The metadata can be directed to multiple conformance operating points.

The control unit 306 directs the encoding process for generating the primary coded bitstream. The control unit 306 also directs the generation of the metadata. The metadata accompanying the primary coded bitstream can be generated by the encoding unit 304 conducting multiple encodings of source video data. The results of each encoding process can be stored by the encoder 200. Coding parameters of each encoding process can be extracted by the control unit 306 for formatting and delivery to the intermediate encoder. Coding parameters can also be derived based on the encoding of the primary coded bitstream or the coding parameters generated during the multiple encodings of the source video data.

As previously mentioned, the primary coded bitstream can be transmitted by the encoding unit 304 over a first portion of the communication channel 204 to the intermediate encoder and the metadata can be transmitted by the control unit 306 over a second portion of the communication channel 204 to the intermediate encoder. Alternatively, the metadata can be encoded as a part of the primary coded bitstream (e.g., as SEI messages).

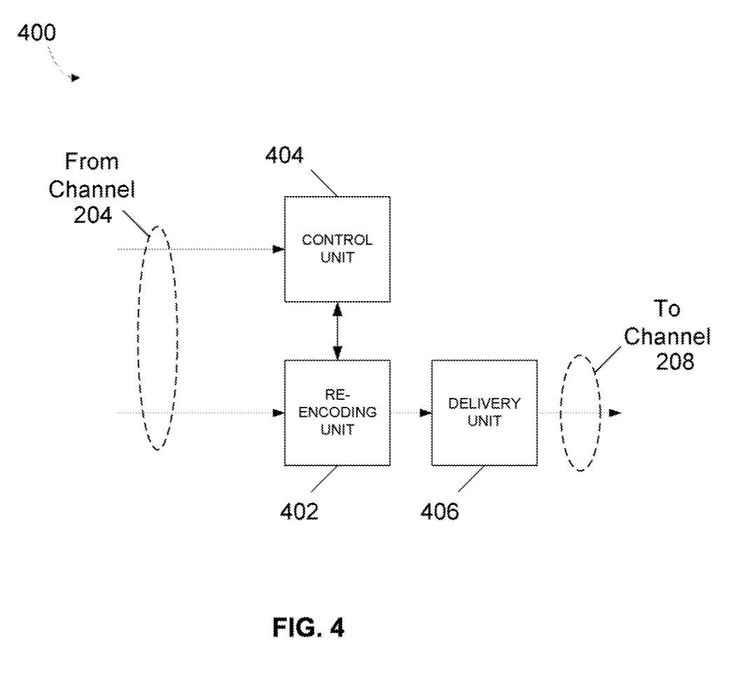

FIG. 4 is a functional block diagram of an intermediate encoder 400 according to an embodiment of the present invention. The intermediate encoder 400 includes a re-encoding unit 402, a control unit 404 and a delivery unit 406. The re-encoding unit 402 can receive the primary coded bitstream from a head-end encoder over a first portion of the communication channel 204. The control unit 404 can receive the metadata from the head-end encoder over a second portion of the communications channel 204. Alternatively, the intermediate encoder 400 can receive the metadata as a portion of the primary coded bitstream (e.g., as SEI messages within the primary coded bitstream). The control unit 404 can then extract metadata. The extracted metadata can be used by the re-encoding unit to recode the primary coded bitstream as necessary to generate multiple secondary coded bitstreams. The control unit 404 can initiate or adjust the re-encoding processes based on received user-supplied information as described above. The resulting secondary coded bitstreams can be stored in the delivery unit 406 and/or can be distributed to various downstream end-user devices by the delivery unit 406. The delivery unit 406 transmits the re-encoded bitstreams over the communications channel 208.

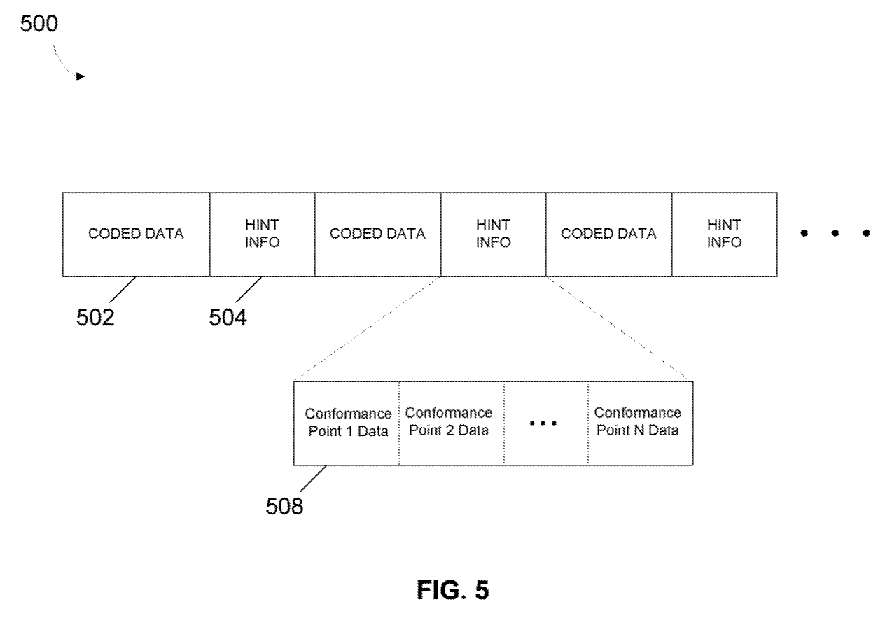

FIG. 5 illustrates a transmission signal 500 generated by an encoder of the present invention for delivery to an intermediate re-encoder of the present invention. As shown in FIG. 5, the transmission signal 500 comprises coded video data 502 and hint information or metadata 504. Collectively, the coded video data 502 represents the primary coded bitstream generated by an encoder of the present invention. The metadata 504 represents the metadata that accompanies the primary coded bitstream. The metadata 504 comprises conformance point information 506 for various conformance points. The conformance point information can represent the coding parameters that can be used to re-encode the primary coded bitstream to produce a secondary coded bitstream for a particular conformance operating point. In this way, the metadata 504 can identify which coding parameters to use to generate a secondary coded bitstream matched a particular type of downstream device. The metadata 504 is shown interleaved with the coded video data 502 in accordance with a particular interleaving format. The particular formatting and arrangement of data shown in the transmission signal 500 is not limited as such. As previously mentioned, the specific formatting and arrangement of data in the transmission signal is immaterial to the purposes of the invention. That is, any formatting and arrangement of metadata 504 and coded video data 502 that provides out-of-band signaling of the metadata 504 is within the contemplated scope of the invention.

A transmission signal generated by an encoder of the present invention for delivery to an intermediate re-encoder of the present invention is not limited to the depiction shown in FIG. 5. Specifically, the metadata can be encoded as a portion of the primary coded bitstream (e.g., as SEI messages). In this way, the provided metadata is conveyed in accordance with the H.264 standard. Interleaving of the coded video data and metadata is not as shown in FIG. 5 as the metadata is incorporated into the formatting/syntax of the coded video bitstream. By supplying the metadata in this fashion, the metadata can be used as soon as it is received (e.g., on a frame-by-frame basis) such that a decoder need not wait for all the metadata to be received before it can be used for recoding operations.

The metadata can also be encoded as an encoded bitstream separate from the primary coded bitstream. This separately encoded metadata bitstream can then be downloaded separately from the primary coded bitstream (e.g., as a separate file) or communicated in an out-of-band signaling channel.

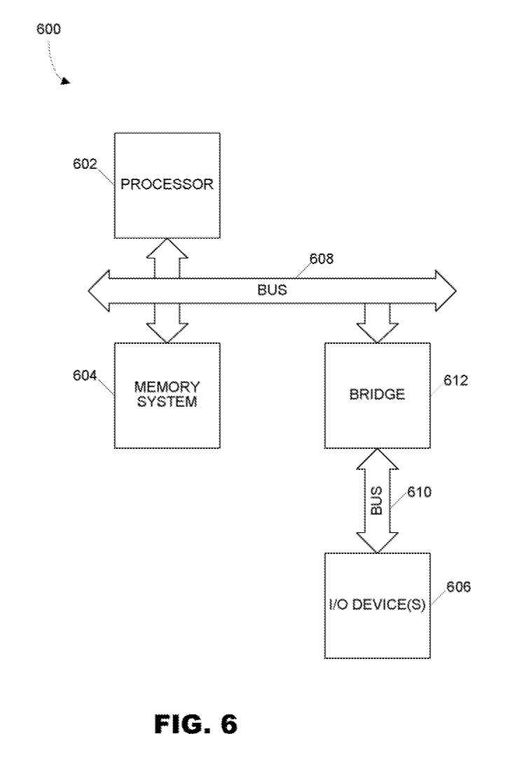

An encoder and decoder of the present invention can be implemented in hardware, software or some combination thereof. For example, an encoder and/or decoder of the present invention can be implemented using a computer system. FIG. 6 is a simplified functional block diagram of a computer system 600. The computer system 600 can be used to implement the encoder 200 or the decoder 300 depicted in FIGS. 2 and 3, respectively.

As shown in FIG. 6, the computer system 600 includes a processor 602, a memory system 604 and one or more input/output (I/O) devices 606 in communication by a communication ‘fabric.’ The communication fabric can be implemented in a variety of ways and may include one or more computer buses 608, 610 and/or bridge devices 612 as shown in FIG. 6. The I/O devices 606 can include network adapters and/or mass storage devices from which the computer system 600 can receive compressed video data for decoding by the processor 602 when the computer system 600 operates as a decoder. Alternatively, the computer system 600 can receive source video data for encoding by the processor 602 when the computer system 600 operates as an encoder.

### CONCLUSION

While various embodiments of the present invention have been described above, it should be understood that they have been presented by way of example and not limitation. It will be apparent to one skilled in the pertinent art that various changes in form and detail can be made therein without departing from the spirit and scope of the invention. Therefore, the present invention should only be defined in accordance with the following claims and their equivalents.

What is claimed is:

1. A scalable encoding method, comprising:
encoding source video according to a primary coding profile to generate a primary coded bitstream;
encoding the source video according to a plurality of secondary coding profiles to generate a plurality of corresponding secondary coded bitstreams; and
deriving metadata based on generation of the plurality of secondary coded bitstreams;
wherein the metadata comprises coding parameters to recode the primary coded bitstream to regenerate the plurality of secondary coded bitstreams.

2. The scalable encoding method of claim 1, wherein the metadata identifies which coding parameters to use to recode the primary coded bitstream to regenerate each of the secondary coded bitstreams.

3. The scalable encoding method of claim 1, wherein the primary coding profile is based on a maximum conformance operating point of a video decoding device.

4. The scalable encoding method of claim 1, wherein deriving comprises including one of the secondary coded bitstreams in the metadata.

5. The scalable encoding method of claim 1, wherein deriving comprises determining coding parameters to generate an additional secondary coded bitstream based on the metadata derived from generation of the plurality of secondary coded bitstreams.

6. The scalable encoding method of claim 1, further comprising receiving video decoding device conformance operating point information.

7. The scalable encoding method of claim 1, wherein deriving further comprises determining prediction mode decision information for at least one secondary coded bitstream.

8. The scalable encoding method of claim 1, wherein deriving further comprises determining frame type information for at least one secondary coded bitstream.

9. The scalable encoding method of claim 1, wherein deriving further comprises determining slice type information for at least one secondary coded bitstream.

10. The scalable encoding method of claim 1, wherein deriving further comprises determining motion vector information for at least one secondary coded bitstream.

11. The scalable encoding method of claim 1, wherein deriving further comprises determining frame quantization parameters for at least one secondary coded bitstream.

12. The scalable encoding method of claim 1, wherein deriving further comprises determining resolution scaling cropping information for at least one secondary coded bitstream.

13. The scalable encoding method of claim 1, wherein deriving further comprises determining Low Complexity (LC) profile values for at least one secondary coded bitstream.

14. The scalable encoding method of claim 1, wherein deriving further comprises determining pre-processing instructions for at least one secondary coded bitstream.

15. The scalable encoding method of claim 1, wherein deriving further comprises determining post-processing instructions for at least one secondary coded bitstream.

16. The scalable encoding method of claim 1, wherein deriving further comprises determining temporal scalability information for at least one secondary coded bitstream.

17. The scalable encoding method of claim 1, further comprising encoding the metadata as part of the primary coded bitstream.

18. The scalable encoding method of claim 17, wherein the metadata is encoded as Supplemental Enhancement Information (SEI).

19. The scalable encoding method of claim 1, further comprising encoding the metadata as a bitstream separate from the primary coded bitstream.

20. A scalable encoded video signal created from a method comprising:
encoding source video according to a primary coding profile to generate a primary coded bitstream;
encoding the source video according to a plurality of secondary coding profiles to generate a corresponding plurality of secondary coded bitstreams;
deriving metadata based on generation of the plurality of secondary coded bitstreams; and
encoding the metadata as part of the primary coded bitstream to form the scalable encoded video signal;
wherein the metadata comprises coding parameters to recode the primary coded bitstream to regenerate the plurality of secondary coded bitstreams.

21. The scalable encoded video signal of claim 20, wherein the metadata is encoded as Supplemental Enhancement Information (SEI).

22. A scalable encoded video signal created from a method comprising:
encoding source video according to a primary coding profile to generate a primary coded bitstream;
encoding the source video according to a plurality of secondary coding profiles to generate a corresponding plurality of secondary coded bitstreams;
deriving metadata based on generation of the plurality of secondary coded bitstreams; and
encoding the metadata as a bitstream separate from the primary coded bitstream, wherein the primary coded bitstream and the encoded metadata bitstream form the scalable encoded video signal;
wherein the metadata comprises coding parameters to recode the primary coded bitstream to regenerate the plurality of secondary coded bitstreams.

23. The scalable encoded video signal of claim 22, wherein the encoded metadata bitstream is interleaved with the primary coded bitstream.

24. A scalable encoding method, comprising:
receiving a primary coded bitstream encoded according to a primary coding profile;
receiving metadata based on generation of a plurality of secondary coded bitstreams encoded according to a plurality of corresponding secondary coding profiles; and
recoding the primary coded bitstream based on the metadata to regenerate at least one of the plurality of secondary coded bitstreams;
wherein the metadata comprises coding parameters to recode the primary coded bitstream to regenerate the plurality of secondary coded bitstreams.

25. The scalable encoding method of claim 24, further comprising recoding the primary coded bitstream based on the metadata and a request from a user of a decoding device to generate a customized bitstream.

26. The scalable encoding method of claim 25, wherein the customized bitstream is matched to a coding profile that is different from each of the plurality of secondary coding profiles.

27. The scalable encoding method of claim 24, wherein the metadata identifies which coding parameters to use to recode the primary coded bitstream to regenerate each of the secondary coded bitstreams.

28. The scalable encoding method of claim 24, wherein the primary coding profile is based on a maximum conformance operating point of a video decoding device.

29. The scalable encoding method of claim 24, wherein the metadata comprises one of the secondary coded bitstreams.

30. The scalable encoding method of claim 24, wherein the metadata comprises coding parameters to generate an additional secondary coded bitstream derived from the metadata developed from generation of the plurality of secondary coded bitstreams.

31. The scalable encoding method of claim 24, wherein recoding further comprises conducting a full re-encoding of the primary coded bitstream to regenerate one of the secondary coded bitstreams.

32. The scalable encoding method of claim 24, wherein recoding further comprises conducting a partial decoding and partial re-encoding of the primary coded bitstream to regenerate one of the secondary coded bitstreams.

33. The scalable encoding method of claim 24, the metadata comprises prediction mode decision information associated with at least one secondary coded bitstream.

34. The scalable encoding method of claim 24, wherein the metadata comprises motion vector information associated with at least one secondary coded bitstream.

35. The scalable encoding method of claim 24, wherein the metadata comprises frame quantization parameters associated with at least one secondary coded bitstream.

36. The scalable encoding method of claim 24, wherein the metadata comprises resolution scaling cropping information associated with at least one secondary coded bitstream.

37. The scalable encoding method of claim 24, wherein the metadata comprises Low Complexity (LC) profile values associated with at least one secondary coded bitstream.

38. The scalable encoding method of claim 24, wherein the metadata comprises pre-processing instructions associated with at least one secondary coded bitstream.

39. The scalable encoding method of claim 24, wherein the metadata comprises post-processing instructions associated with at least one secondary coded bitstream.

40. The scalable encoding method of claim 24, wherein the metadata comprises temporal scalability information associated with at least one secondary coded bitstream.

41. The scalable encoding method of claim 24, further comprising receiving the metadata as part of the primary coded bitstream.

42. The scalable encoding method of claim 41, wherein the metadata is encoded as Supplemental Enhancement Information (SEI).

43. The scalable encoding method of claim 24, further comprising receiving the metadata as an encoded bitstream separate from the primary coded bitstream.

44. The scalable encoding method of claim 43, wherein the encoded metadata bitstream is interleaved with the primary coded bitstream.

45. The scalable encoding method of claim 24, further comprising recoding the primary coded bitstream based on the metadata and one or more received enhancement layers.

46. The scalable encoding method of claim 24, further comprising recoding the primary coded bitstream based on metadata derived from the received metadata to generate a bitstream matched to a coding profile that is different from each of the plurality of secondary coding profiles.
